(19) United States
(12) Patent Application Publication
(10) Pub. No.: US 2005/0248517 A1
(43) Pub. Date: Nov. 10, 2005

(54) System and method for luminance degradation reduction using thermal feedback

(75) Inventor: Paul Fredrick Luther Weindorf, Novi, MI (US)

Correspondence Address: VISTEON, C/O BRINKS HOFER GILSON & LIONE, PO BOX 10395, CHICAGO, IL, 60610, US

(73) Assignee: Visteon Global Technologies, Inc.

(21) Appl. No.: 10/840,039

(22) Filed: May 5, 2004

(51) Int. Cl. G09G 3/32

(52) U.S. Cl. 345/82

(57) ABSTRACT

A system to compensate for luminance degradation of an emissive display is provided. As its primary components, the system includes a controller and a temperature sensor. The controller is coupled to the emissive display to provide a driving signal thereby controlling the display luminance. The temperature sensor is located proximate the emissive display and is in electrical communication with the controller. The controller receives a temperature signal from the temperature sensor and varies the luminance based on the temperature signal. As the temperature of the emissive display increases, the controller reduces the display luminance according to a transfer function. The transfer function may have a linear term and/or a non-linear term relating the operating luminance to the display temperature.

### BACKGROUND

1. Field of the Invention

The present invention generally relates to a system and method to compensate for luminance degradation using thermal feedback.

2. Description of Related Art

In the portable display industry, much excitement has been generated surrounding the use of organic light emitting diode (OLED) displays. OLED displays are self-luminous and do not require backlighting. Therefore, these displays are thin and very compact. OLED displays have a wide viewing angle and generally require very little power. However, emissive display technologies, such as OLED displays, suffer from differential aging, and must be carefully analyzed and used to ensure that lifetime expectations are met. Differential aging is where portions or colors of the display used more frequently emit a lower luminance than portions used less frequently. Light valve technology such as liquid crystal, interferometric modulator, LCOS, micro-mirror, and electrophoretic displays do not suffer from differential aging because they depend on a general light source that decays independent of localized screen use. Since emissive technology displays suffer from differential aging, screen saver functions are required if the same data is displayed over long periods of time. Although OLED displays have many benefits, their major disadvantage is aging. In addition, aging of OLED displays is accelerated substantially at elevated temperatures, commonly associated with automotive environments.

In view of the above, it is apparent that there exists a need for an improved system and method to allow OLED displays to function at elevated temperatures while improving aging characteristics of the display.

### SUMMARY

In satisfying the above need, as well as overcoming the enumerated drawbacks and other limitations of the related art, the present invention provides a system to compensate for luminance degradation of an emissive display. As its primary components, the system includes a controller and a temperature sensor. The controller is coupled to the emissive display to provide a driving signal thereby controlling the display luminance. The temperature sensor is located proximate the emissive display and is in electrical communication with the controller. The controller receives a temperature signal from the temperature sensor and varies the luminance based on the temperature signal. As the temperature of the emissive display increases, the controller reduces the display luminance according to a transfer function. The transfer function may have a linear term and/or a non-linear term relating the operating luminance to the display temperature.

In another aspect of the present invention, the controller defines two temperature ranges, the first temperature range controlling display luminance for hot temperatures and the second temperature range controlling the luminance for normal operation. For example, during a hot start above 25° C. the display luminance is de-rated based on temperature, while below 25° C. the display luminance remains at full luminance. Linear and non-linear transfer functions may be used to de-rate the display luminance, however, preferably the luminance will be de-rated from 100% at 25° C. to about 50% at 85° C. In addition, a non-linear or exponential transfer function may be utilized. Further, an exponential de-rating may be based on the luminance degradation model provided herein.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a block diagram of a system to compensate for luminance degradation of an emissive display in accordance with the present invention;

FIG. 2 is a plot of the luminance output over time for yellow OLEDs at 50° C.;

FIG. 3 is a plot of the luminance output over time for yellow OLEDs at 70° C.;

FIG. 4 is a plot of the luminance output over time for yellow OLEDs at 80° C.;

FIG. 5 is a plot illustrating the number of hours required to reach 10% luminance degradation with respect to temperature;

FIG. 6 is a plot of an exponential equation used to estimate the number of hours required to reach 10% luminance degradation with respect to temperature;

FIG. 7 is a plot of the consumption rate for an automotive hot start;

FIG. 8 is a plot of an estimated consumption rate for an automotive application; and

FIG. 9 is a plot comparing the actual consumption rate for an automotive application at 50° C. compared to the estimated consumption rate for an automotive application at 50° C.

### DETAILED DESCRIPTION

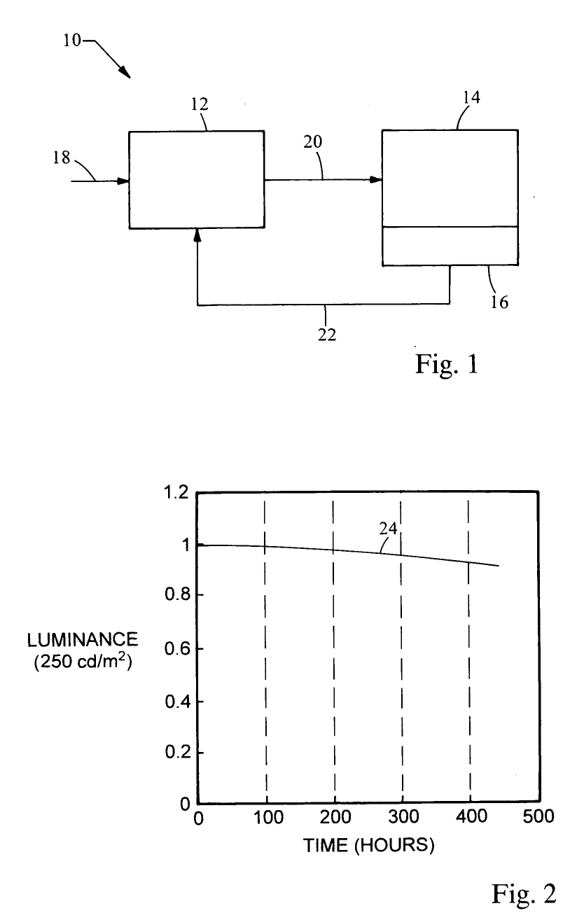

Referring now to FIG. 1, a system embodying the principles of the present invention is illustrated therein and designated at 10. As its primary components, the system 10 includes a control circuit 12, an emissive display 14, and a temperature sensor 16. A desired luminance signal 18 is provided to the control circuit 12, the desired luminance signal 18 is often generated from a display brightness control (not shown). The control circuit 12 generates a display drive signal 20 based on the desired luminance signal 18. The display drive signal 20 is provided to the emissive display 14, causing the emissive display 14 to operate at a specific display luminance level. The temperature sensor 16 is located proximate the emissive display 14 and configured to monitor a temperature of the emissive display 14. The temperature sensor 16 generates a feedback signal 22 which is received by the control circuit 12. The feedback signal 22 is indicative of the temperature measured by the temperature sensor 16 and is used to de-rate the display driving signal 20 based on the desired luminance signal 18.

De-rating the display driving signal 20, has a profound impact on the life of the emissive display 14 because the analysis presented herein shows that the major loss is not due to normal operation, but rather, due to the operation time during initial hot temperature starts. Particularly, the luminance degradation caused by running at hot temperatures is exponential in nature. Therefore, by decreasing the luminance as a function of temperature, until the cabin of the vehicle is within a normal operating temperature can greatly increase the life and performance of the emissive display 14. For example, the processor 12 may run at full luminance up to 20-30° C. The processor 12 may decrease the luminance of the emissive display 14 linearly from full luminance at about 25° C. to 50% of full luminance at about 85° C., and at least between about 80° C.-90° C. Although, other temperature ranges may be used depending on the application and display design. Further, a transfer function may be developed to incorporate non-linear schemes for de-rating the display luminance and may be based on a projected luminance degradation transfer function.

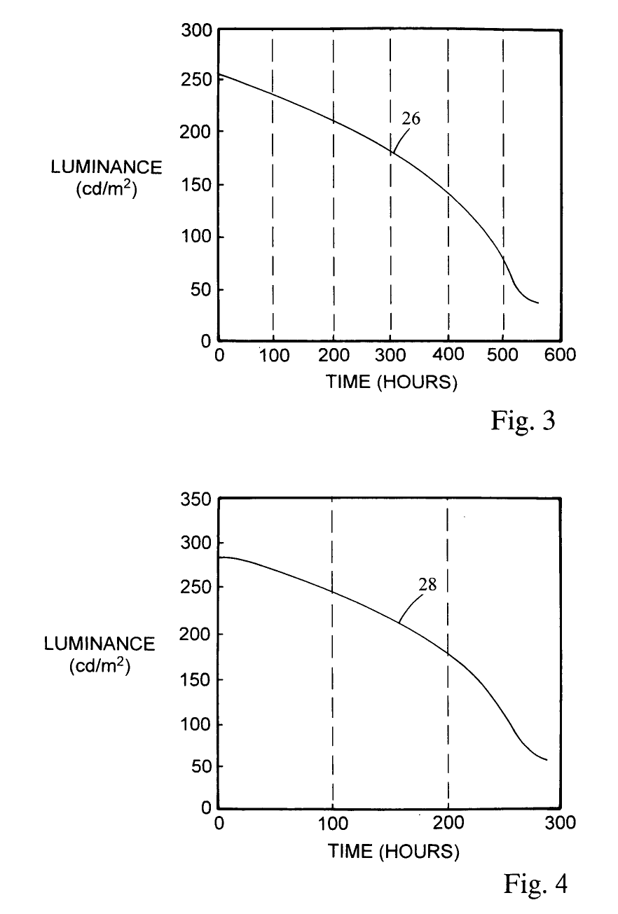

To calculate a projected luminance degradation, the degradation of OLED elements at differing temperatures must be analyzed. FIGS. 2, 3, and 4 show plots of luminance output over time for a typical OLED. Specifically, line 24 corresponds to the luminance at 50° C., line 26 corresponds to the luminance at 70° C., and line 28 corresponds to the luminance at 80° C. One important feature from these plots is that the luminance decay is approximately linear until about 50% luminance degradation. Therefore, it can be concluded that the luminance degradation is additive in nature, greatly simplifying the mathematics required to project luminance degradation. The additive nature of the degradation implies that the degradation at various temperatures can be added to determine the total luminance degradation over time.

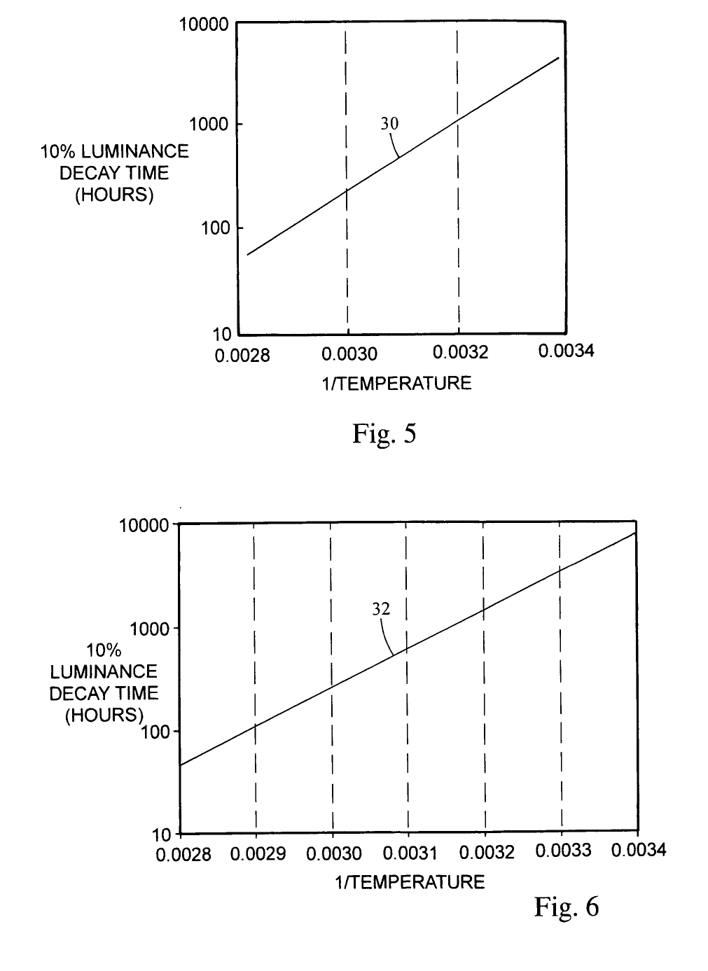

FIG. 5 shows a plot 30 illustrating the number of hours required to reach 10% luminance degradation with respect to temperature. Plot 30 is approximately linear on a log scale as a function of 1/T, where T is the temperature in Kelvin. The logarithmic relationship between the time to 10% luminance degradation and the temperature indicates that the equation for luminance degradation with respect to temperature can be expressed by Equation (1).
Hours₋₁₀%=K₁e^{K}^{₂}^{(1/T)} (1)

Notably, the decay time decreases more than exponentially as the temperature increases. Since the rate of luminance degradation at each temperature is approximately linear down to 50% of full luminance, any decay point down to 50% may be used to solve for the constants K1 and K2 in Equation (1). Based on the plot shown in FIGS. 2 and 4, Equations (2)-(10) are provided to solve for K₁ and K₂.
600=K₁e^{K}^{₂}^{(0.0031)} for T=50° C.+273° C. (2)
60=K₁e^{K}^{₂}^{(0.00283)} for T=80° C.+273° C. (3)

$$\begin{matrix}\frac{600}{{ⅇ}^{{K}_{2} ( 0.0031 )}} = \frac{60}{{ⅇ}^{{K}_{2} ( 0.00283 )}} & ( 4 ) \\ \frac{600}{60} = {ⅇ}^{{K}_{2} ( 0.0031 ) - {K}_{2} ( 0.00283 )} & ( 5 ) \\ \frac{600}{60} = {ⅇ}^{{K}_{2} ( 0.0031 - 0.00283 )} & ( 6 )\end{matrix}$$

In(10)=K₂(2.7×10⁻⁴) (7)
K₂=8.53K (8)
600=K₁e^{(8.53K)(0.0031)} (9)
K₁=1.968×10⁻⁹ (10)

Substituting K₁ and K₂ into Equation (1) yields Equation (11).
H_{-10%}=1.968×10⁻⁹e^{8.53K(1/T)} (11)

A plot 32 corresponding to Equation (11) is provided in FIG. 6. To verify Equation (11), plot 32 can be compared with plot 30 from FIG. 5, showing the imperical data provided in FIGS. 2-4 are consistent with Equation (11). Since the rate of luminance degradation is linear with respect to temperature, integration techniques can be applied to Equation (11), to model the life of the OLED. Generally, the consumption rate at a given temperature can be expressed as Equation (12).

$$ConsumptionRate = CR = \frac{Nits}{Hour} \qquad ( 12 )$$

The relationship in Equation (12) expresses that the luminance degradation measured in Nits is proportional to the number of hours operated at room temperature. Noting that Equation (11) is defined as the relationship between the time that the luminance degrades by 10% with respect to temperature, Equation (11) may be substituted into Equation (12) for a specified luminance degradation of 0.1 or 10%. The resulting relationship of consumption rate with respect to luminance and temperature is provided in Equation (13).

$$CR = \frac{{L}_{i} ( 0.1 )}{1.968 \times {10}^{- 9} {ⅇ}^{8.53 K ( 1 / T )}} \qquad ( 13 )$$

where Lᵢ is the Initial Luminance and
T is the temperature in Kelvin

Equation (13) may be further developed for an automotive environment. In an automotive environment, temperature inside the cabin generally changes in an exponential manner. For instance, when a user enters the automobile after it has been sitting in the sun, the temperature will generally decrease to a comfortable cabin temperature in an exponential manner assuming the air conditioning is functioning. Therefore, the temperature function can be modeled by the relationship provided in Equation (14).
T=T₂+ΔTe^{-1/τ} (14)
where
T₁ is the initial temperature,
T₂ is the final temperature,
ΔT=T₁−T₂, and
τ=time constant

Substituting Equation (14) into Equation (13) yields Equation (15).

$$CR = \frac{{L}_{i} ( 0.1 )}{1.968 \times {10}^{- 9} {ⅇ}^{8.53 K ( \frac{1}{{T}_{2} + Δ T {ⅇ}^{- t / τ}} )}} \qquad ( 15 )$$

Equation (15) can be integrated over time to yield the total luminance degradation for a particular hot start as provided in Equation (16).

$$\begin{matrix}Luminance\_Decrease = LD \\ = {\int }_{0}^{t} \frac{{L}_{i} ( 0.1 )}{1.968 \times {10}^{- 9} {ⅇ}^{8.53 K ( \frac{1}{{T}_{2} + Δ T {ⅇ}^{- t / τ}} )}} ⅆ t\end{matrix} \qquad ( 16 )$$

For example, an automotive hot start model may be developed using a starting temperature T₂=85° C., an ending temperature T₁=25° C., a full luminance of 250 Nits, and a time constant of τ=20 minutes for a typical cooling time. Equation (17) is representative of Equation (16) including the substitution of the hot start values noted above.

$$LD = {\int }_{0}^{t} \frac{25}{1.968 \times {10}^{- 9} {ⅇ}^{8.53 K ( \frac{1}{298 + 60 {ⅇ}^{- t / 0.15}} )}} ⅆ t \qquad ( 17 )$$

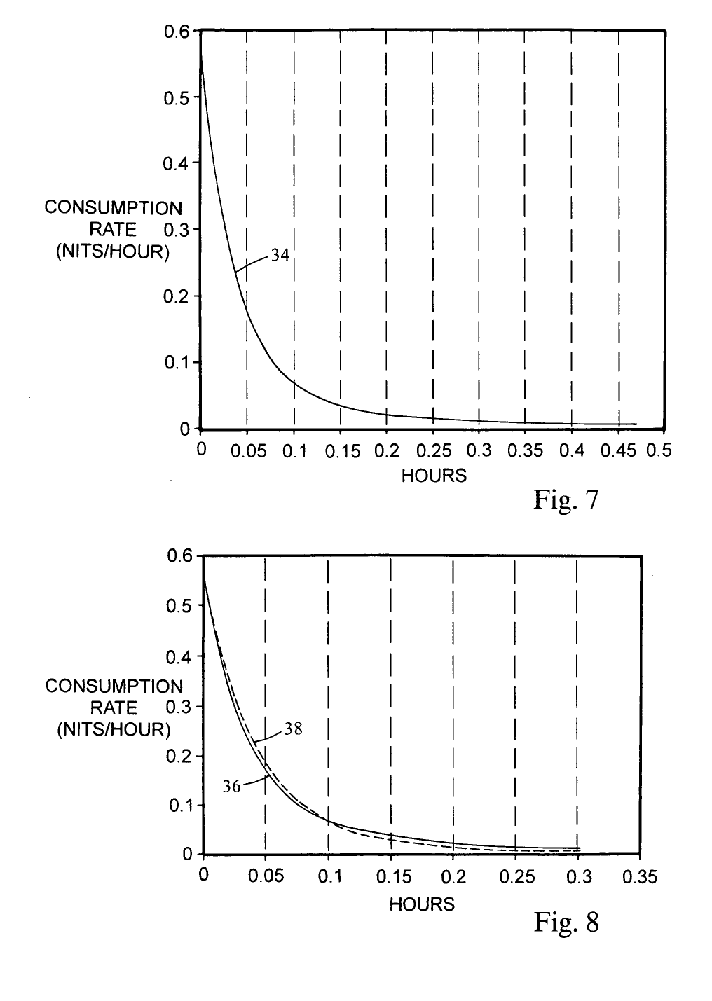

A plot of Equation (17) is provided as line 34 in FIG. 7. Realizing the complex routine required to perform the integral provided in Equation (17) in real time, the relationship described in Equation (17) may be estimated as an exponential relationship as the plot 34 appears to be approximately exponential in nature. Accordingly, an exponential function will be fit to Equation (17) based on the plot 34 shown in FIG. 7. Accordingly, the initial value of the consumption rate is determined per Equation (18).

$$CR = \frac{250 ( 0.1 )}{1.968 \times {10}^{- 9} {ⅇ}^{8.53 K ( \frac{1}{298 + 60} )}} = 0.570 \frac{Nits}{Hour} \qquad ( 18 )$$

Further, as shown in Equation (19), the final value of the consumption rate is calculated as time goes to infinity.
At t=∞

$$CR = \frac{250 ( 0.1 )}{1.968 \times {10}^{- 9} {ⅇ}^{8.53 K ( \frac{1}{298} )}} = 0.0047 \frac{Nits}{Hour} \qquad ( 19 )$$

From Equation (18), the final value of the consumption rate approaches 0.0047 and the difference between the results of Equation (18) and Equation (19) is 0.5653. Substituting these results into standard exponential form, the curve fit function of Equation (20) can be developed.
CR=0.0047+0.5653e^{-1/0.045} (20)

FIG. 8 shows a comparison of plot 36 from the imperical consumption rate in Equation (17) and plot 38 from the estimated consumption rate in Equation (20). Substituting Equation (20) into the integral of Equation (17) yields Equation (21).

$$\begin{matrix}LD = {\int }_{0}^{t} 0.0047 + 0.5653 {ⅇ}^{\frac{- t}{0.045}} ⅆ t \\ = 0.0047 t + \frac{0.5653 {ⅇ}^{\frac{- t}{0.045}}}{( \frac{- 1}{0.045} )} {\vert}_{0}^{′} \\ = 0.0047 t + [ \frac{0.5653 {ⅇ}^{\frac{- t}{0.045}}}{( \frac{- 1}{0.045} )} - \frac{0.5653}{( \frac{- 1}{0.045} )} ] \\ LD = 0.0047 t + ( 0.5653 ) ( 0.045 ) [ 1 - {ⅇ}^{\frac{- t}{0.045}} ] \\ = 0.0047 t + 0.02544 [ 1 - {ⅇ}^{\frac{- t}{0.045}} ]\end{matrix} \qquad ( 21 )$$

From observation of Equation (21), when t>>0.045 hours (2.7 minutes), 0.02544 Nits of luminance degradation will have occurred. Therefore, each hot start degrades the luminance of the display by 25.44 mNits. The 0.0047t term shows that for each hour of operation at room temperature, the luminance will be decreased by 4.7 mNits.

Similar to the above discussion, 50° C. is substituted in Equation (13) yielding Equations (22)-(23) to determine the consumption rate of a 50° hot start.

$$\begin{matrix}CR = \frac{250 ( 0.1 )}{1.968 \times {10}^{- 9} {ⅇ}^{8.53 K ( \frac{1}{298 + 25 {ⅇ}^{\frac{- t}{.15}}} )}} & ( 22 ) \\ At t = 0 , & \\ CR = \frac{25}{1.968 \times {10}^{- 9} {ⅇ}^{8.53 K ( \frac{1}{298 + 25} )}} = 0.043129 \frac{Nits}{Hour} & ( 23 )\end{matrix}$$

Specifically, at t=∞, the CR=0.0047, which is the same as in Equation (20). Substituting these results into standard exponential form, the consumption rate at 50° C. can be estimated by the relationship provided in Equation (24).
CR=0.0047+0.038429e^{-1/τ} (24)

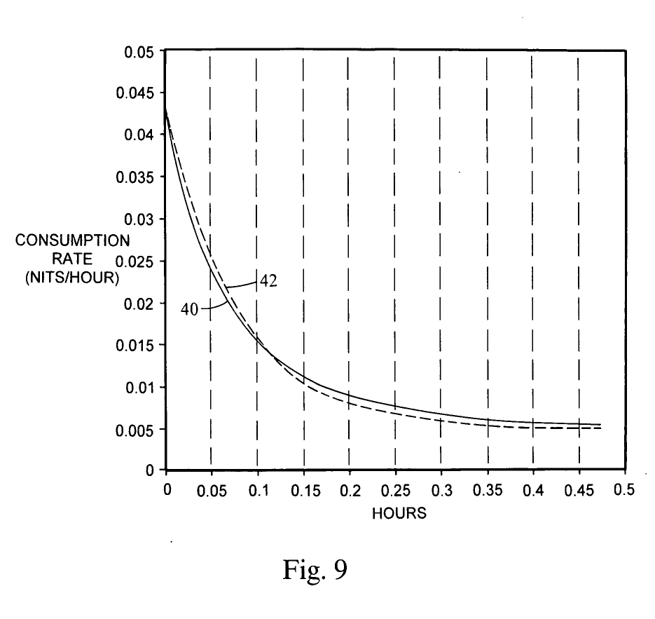

Now referring to FIG. 9, plot 40 corresponds to Equation (17) at 50° C. Similarly, plot 42 corresponds to the consumption rate as provided by Equation (24). Observing plots 40 and 42 in FIG. 9, it can be determined that the time constant of 0.08 is a better choice than the time constant 0.045 used for the 85° C. equation. Substituting and the 0.08 time constant and integrating the Equation (24) yields Equation (25).

$$\begin{matrix}LD = {\int }_{0}^{t} 0.0047 + 0.038429 {ⅇ}^{\frac{- t}{0.08}} ⅆ t \\ = 0.0047 t + \frac{0.038429 {ⅇ}^{\frac{- t}{0.08}}}{( \frac{- 1}{0.08} )} {\vert}_{0}^{t} \\ = 0.0047 t + [ \frac{0.038429 {ⅇ}^{\frac{- t}{0.08}}}{( \frac{- 1}{0.08} )} - \frac{0.038429}{( \frac{- 1}{0.08} )} ] \\ LD = 0.0047 t + ( 0.038429 ) ( 0.08 ) [ 1 - {ⅇ}^{\frac{- t}{0.08}} ] \\ = 0.0047 t + 0.00307 [ 1 - {ⅇ}^{\frac{- t}{0.08}} ]\end{matrix} \qquad ( 25 )$$

From the results of Equation (25), it can be observed that the luminance degradation of 0.00307 Nits due to the 50° C. hot start is much less than the 0.02544 Nits consumed by an 85° C. hot start.

To further expand the Equations above to account for various OLED drive levels, it can be assumed that the lifetime of OLED devices is inversely proportional to the luminance level. For instance, if a display has a half-life of 10,000 hours for the corresponding luminance of 100 Nits, then it is expected to have a half-life of 1,000 hours if tested under 1000 Nits condition. Further, it is assumed that this relationship holds under different temperatures. Adapting the Equations above to account for the drive level relationship, the consumption rate formulas are modified by multiplying the equations by the factor L_{OP}/L_{N}, where L_{OP} is operating luminance and L_{N} is the normal operating luminance. Since the integral of a constant times a function is the constant times the integral of the function, the luminance degradation formula can simply be multiplied by L_{OP}/L_{N}. Therefore, the new equations for luminance degradation are provided in Equation (26) for 50° C. and Equation (27) for 85° C.

$$\begin{matrix}{LD}_{50 C} = \frac{{L}_{OP}}{{L}_{N}} \{ 0.0047 t + ( 0.038429 ) ( 0.08 ) [ 1 - {ⅇ}^{\frac{- t}{0.08}} ] \} & ( 26 ) \\ = \frac{{L}_{OP}}{{L}_{N}} \{ 0.0047 t + 0.00307 [ 1 - {ⅇ}^{\frac{- t}{0.08}} ] \} & \\ {LD}_{85 C} = \frac{{L}_{OP}}{{L}_{N}} \{ 0.0047 t + ( 0.5653 ) ( 0.045 ) [ 1 - {ⅇ}^{\frac{- t}{0.045}} ] \} & ( 27 ) \\ = \frac{{L}_{OP}}{{L}_{N}} \{ 0.0047 t + 0.02544 [ 1 - {ⅇ}^{\frac{- t}{0.045}} ] \} & \end{matrix}$$

Further expanding these formulas to apply to an automotive application, an estimate of how the OLED material will decrease in luminance in a worst case scenario, such as, Phoenix, Ariz. is determined utilizing Equations (26) and (27). Assuming 10 years at 15,000 miles per year (150,000 miles total) and an average speed of 30 miles, per hour, the total number of operational hours is determined per Equation (28) as 5000 hours.

$${HOURS}_{OPERATIONAL} = \frac{150 Kmiles}{30 \frac{mi}{hour}} = 5000 hours \qquad ( 28 )$$

Assuming half the driving is during nighttime and half the driving is during daytime, and also assuming half driving is during summer and half the driving is during winter, this would yield approximately 2 hot starts per day during the summer wherein the internal cabin temperature is approximately 85° C. The number of hot starts can be determined according to Equation (29) as 3650 hot starts.

$$10 years \times 365 days \times \frac{1}{2} summer \times 2 hot\_starts / day = 3650 hot\_starts \qquad ( 29 )$$

Assuming 85° C. hot starts Equation (27) indicates each hot start will consume 25.44 mNits. Therefore, multiplying 25.44 mNits×3650 hot starts yields Equation (30).
∴3650hot_starts×25.44 mNits=92.8 Nits (30)

Equation 30 predicts that the OLED luminance will decrease by 92.8 Nits due to 85° C. hot starts further assuming that L_{OP}=L_{N} for daytime operation. The total operating time at 25° C. during full 240 Nit daytime luminance is ½ of the total 5000 hours or 2500 hours. For full luminance daytime operation, L_{OP}/L_{N}=1. Therefore, as provided by Equation (31), 11.5 Nits are consumed during normal daytime operation.
∴2500 hours×0.0047 Nits/hour=11.75 Nits (31)

Assuming 40 Nits for nighttime operation at 25° C. for 2500 hours yields Equation (32).

$$∴ 2500 hours \times 0.0047 Nits \text{/} hour \times \frac{40 Nits}{240 Nits} = 1.95 Nits \qquad ( 32 )$$

Equation (32) indicates that approximately 1.95 Nits will be consumed due to nighttime operation. Accordingly, Table 1 is provided as a summary of the total luminance degradation over the lifetime of the display.

TABLE 1

| Condition | Luminance Decrease |
|---|---|
| 3650 + 85° C. Hot Starts | 92.8 Nits |
| 2500 hours @ 240 Nit Day Time | 11.75 Nits |
| Operation | |
| 2500 hours @ 40 Nit Night Time | 1.95 Nits |
| Operation | |
| Total Luminance Decrease @ End of | 106.5 Nits |
| Life | (44% decrease) |

Analysis of Table 1 provides that most of the luminance decrease is caused due to the short time the OLED is operating in a hot condition until the temperature is brought back to normal cabin temperature by the air conditioning. Accordingly, the control luminance during hot starts provides a significant impact on the lifetime of the display.

A simple method for de-rating luminance to control the luminance decrease at hot start includes decreasing the display luminance linearly from full luminance at 25° C. to 50% of full luminance at 85° C. Accordingly, Equations (33)-(39) are used to solve for the operational luminance as a function of temperature in Kelvin.
L_{OP}=mT_{K}+b (33)
L_{N}=m298+b (34)
0.5L_{N}=m358+b (35)
0.5L_{N}=−60m (36)

$$\begin{matrix}∴ m = - \frac{0.5 {L}_{N}}{60} & ( 37 ) \\ b = {L}_{N} + \frac{0.5 ( 298 ) {L}_{N}}{60} = 3.48 {L}_{N} & ( 38 ) \\ {L}_{OP} = - \frac{0.5 {L}_{N} {T}_{K}}{60} + 3.48 {L}_{N} = {L}_{N} [ - \frac{0.5 {T}_{K}}{60} + 3.48 ] & ( 39 )\end{matrix}$$

Equation (39) linearly decreases L_{OP} from L_{N} at 25° C. to 0.5×L_{N} at 85° C. Starting with a known relationship in Equation (40), a new consumption rate formula and luminance degradation formula can be developed to determine the luminance degradation savings obtained by de-rating the luminance at high temperatures.

$$LD = {\int }_{0}^{t} CR ⅆ t = {\int }_{0}^{t} \frac{{L}_{OP}}{{L}_{N}} \frac{250 ( 0.1 )}{1.968 \times {10}^{- 9}} \frac{1}{{ⅇ}^{8.53 K ( \frac{1}{{T}_{K}} )}} ⅆ t \qquad ( 40 )$$

Substituting the operating luminance from Equation (39) into Equation (40) yields Equation (41).

$$LD = \frac{250 ( 0.1 )}{1.968 \times {10}^{- 9}} {\int }_{0}^{t} \frac{{L}_{N} [ \frac{- 0.5 {T}_{K}}{60} + 3.48 ]}{{L}_{N}} \frac{1}{{ⅇ}^{8.53 K ( \frac{1}{{T}_{K}} )}} ⅆ t \qquad ( 41 )$$

Further assuming 20 minutes for the air conditioner to decrease the temperature 60° C. from 85° C. to 25° C. yields a Tₖ according to Equation (42).
T_{K}=298+60e^{-1/0.15} (42)

Substituting Equation (42) into Equation (41) yields Equation (43).

$$LD = \frac{250 ( 0.1 )}{1.968 \times {10}^{- 9}} {\int }_{0}^{t} \frac{{L}_{N} [ \frac{- 0.5 ( 298 + 60 {ⅇ}^{\frac{- t}{0.15}} )}{60} + 3.48 ]}{{L}_{N}} \frac{1}{{ⅇ}^{8.53 K ( \frac{1}{298 + 60 {ⅇ}^{\frac{- t}{0.15}}} )}} ⅆ t \qquad ( 43 )$$

According to the method provided previously in this application, the last term and leading constants can be used to provide a curved fit in accordance with Equation (44).

$$LD = {\int }_{0}^{t} [ \frac{- 0.5 ( 298 + 60 {ⅇ}^{\frac{- t}{0.15}} )}{60} + 3.48 ] [ 0.0047 + 0.5653 {ⅇ}^{\frac{- t}{0.045}} ] ⅆ t \qquad ( 44 )$$

Equations (45)-(50) are provided to show the steps in solving for a curved fit provided in Equation (50).

$$\begin{matrix}LD = {\int }_{0}^{t} [ 1 - 0.5 {ⅇ}^{- t / 0.15} ] [ 0.0047 + 0.5653 {ⅇ}^{- t / 0.045} ] ⅆ t & ( 45 ) \\ \begin{matrix}LD = {\int }_{0}^{t} 0.0047 + 0.5653 {ⅇ}^{- t / 0 / 04.5} - \\ 0.5 ( 0.0047 ) {ⅇ}^{- t / 0.15} - 0.5 ( 0.5653 ) {ⅇ}^{- t / 0.15} {ⅇ}^{- t / 0.045} ⅆ t\end{matrix} & ( 46 ) \\ \begin{matrix}LD = 0.0047 t {\vert}_{0}^{t} + \frac{0.5653 {ⅇ}^{- t / 0.045}}{( \frac{- 1}{0.045} )} {{\vert}_{0}^{t} - \frac{0.5 ( 0.0047 ) {ⅇ}^{- t / 0.15}}{( \frac{- 1}{0.15} )} \vert}_{0}^{t} - \\ 0.5 ( 0.5653 ) {\int }_{0}^{t} {ⅇ}^{- t ( \frac{1}{0.15} + \frac{1}{0.045} )} ⅆ t\end{matrix} & ( 47 ) \\ \begin{matrix}LD = 0.0047 t - 0.0254 {ⅇ}^{- t / 0.045} {{\vert}_{0}^{t} + 0.0003525 {ⅇ}^{- t / 0.15} \vert}_{0}^{t} - \\ 0.5 ( 0.5653 ) {\int }_{0}^{t} {ⅇ}^{- t / 0.0346} ⅆ t\end{matrix} & ( 48 ) \\ \begin{matrix}LD = 0.0047 t + 0.0254 [ 1 - {ⅇ}^{- t / 0.045} ] - \\ 0.0003525 [ 1 - {ⅇ}^{- t / 0.15} ] - \frac{0.28265 {ⅇ}^{- t / 0.0346}}{( \frac{- 1}{0.0346} )} {\vert}_{0}^{t}\end{matrix} & ( 49 ) \\ \begin{matrix}LD = 0.0047 t + 0.0254 [ 1 - {ⅇ}^{- t / 0.045} ] - \\ .0003525 [ 1 - {ⅇ}^{- t / 0.15} ] - 0.0098 [ 1 - {ⅇ}^{- t / 0.0346} ]\end{matrix} & ( 50 )\end{matrix}$$

For Equation (50) it can be observed that the first two terms match the luminance degradation calculated earlier from Equation (21). Therefore, from lowering the luminance by 50% at 85° C., the last two terms indicate the amount of luminance degradation saved during hot starts. Accordingly, the luminance savings is calculated per Equation (51), assuming 3650 hot starts.
LD_{saving}=3650×(0.0003525+0.0098)=55.66 Nits (51)

In summary, Table 2 shows that the luminance degradation has been reduced to 20% in comparison to 44% degradation running the display at full luminance during the hot starts.

TABLE 2

| | | Luminance |
|---|---|---|
| | | Decrease with |
| | Luminance | Temperature |
| Condition | Decrease | Derating |
| 3650 + 85° C. Hot Starts | 92.8 Nits | 37.14 Nits |
| 2500 hours @ 240 Nit | 11.75 Nits | 11.75 Nits |
| Day Time Operation | | |
| 2500 hours @ 40 Nit | 1.95 Nits | 1.95 Nits |
| Night Time Operation | | |
| Total Luminance | 106.5 Nits | 50.84 Nits |
| Decrease @ End of | (44% decrease) | (20% decrease) |
| Life | | |

In addition, similar results can be achieved by de-rating the display luminance starting between 20° C.-30° C. and reaching about 50% luminance between 80° C.-90° C. Further, a non-linear transfer function is readily implemented that de-rates the display luminance based on the luminance degradation curve. One example includes a transfer function that has an inversely proportional relationship to the luminance degradation curve.

As a person skilled in the art will readily appreciate, the above description is meant as an illustration of implementation of the principles this invention. This description is not intended to limit the scope or application of this invention in that the invention is susceptible to modification, variation and change, without departing from spirit of this invention, as defined in the following claims.

1. A system to compensate for luminance degradation of a display, the system comprising:
a controller coupled to the display and configured to provide power to the display thereby controlling the display luminance; and
a temperature sensor proximate the display and in electrical communication with the controller, wherein the controller is configured to vary the display luminance, based on a temperature measured by the temperature sensor.

2. The system according to claim 1, wherein the controller is configured to decrease the display luminance as the temperature of the display increases.

3. The system according to claim 1, wherein the controller is configured to increase the display luminance as the temperature of the display decreases.

4. The system according to claim 1, wherein the controller is configured to vary the display luminance based on a transfer function having a linear term.

5. The system according to claim 4, wherein the controller is configured to vary the display luminance based on the relationship L_{OP}=m*T_{K}+b. where L_{OP} is the display luminance, m is a gain, T_{K} is the temperature of the display, and b is an offset.

6. The system according to claim 1, wherein the controller is configured to define a first and second temperature range and vary the luminance of the display over the first temperature range based on the temperature of the display.

7. The system according to claim 6, wherein the controller is configured to control the luminance of the display to remain a constant value over the second temperature range.

8. The system according to claim 7, wherein a lowest temperature of the first range is between 20° and 30° C.

9. The system according to claim 6, wherein the luminance is at about 100% of full power luminance at the lowest temperature of the first range.

10. The system according to claim 9, wherein the luminance is at about 50% of the full power luminance at between 80° and 90° C.

11. The system according to claim 6, wherein the display luminance in the first temperature range is varied by a transfer function having a linear component.

12. The system according to claim 11, wherein the display luminance is varied based on the relationship L_{OP}=m*T_{K}+b. where L_{OP} is the display luminance, m is a gain, T_{K} is the temperature of the display, and b is an offset.

13. The system according to claim 1, wherein the display luminance is varied based on a luminance degradation function.

14. The system according to claim 13, wherein the display luminance is varied based on a transfer function having an inversely proportional relationship to the luminance degradation function.

15. A method for compensating luminance degradation of an OLED display, the method comprising:
providing power to the OLED display;
measuring a temperature of the OLED display;
varying luminance of the OLED display based on the temperature of the OLED display;

16. The method according to claim 15, decreasing the display luminance as the temperature of the OLED display increases.

17. The method according to claim 15 increasing the display luminance as the temperature of the OLED display decreases.

18. The method according to claim 15, wherein the display luminance is varied based on a transfer function having a linear term.

19. The method according to claim 16, wherein the display luminance is varied based on the relationship L_{OP}=m*T_{K}+b. where L_{OP} is the display luminance, m is a gain, T_{K} is the temperature of the OLED display, and b is an offset

20. The method according to claim 15, further comprising defining a first and second temperature range and varying the luminance of the OLED display over the first temperature range based on the temperature of the OLED display.

21. The method according to claim 20, further comprising controlling the luminance of the OLED display to remain a constant value over the second temperature range.

22. The method according to claim 21, wherein the lowest temperature of the first range is between 20° and 30° C.

23. The method according to claim 20, wherein the luminance is at 100% of the full power luminance at the lowest temperature of the first range.

24. The method according to claim 21, wherein the luminance is at about 50% of the full power luminance at between 80° and 90° C.

25. The method according to claim 20, wherein the display luminance is varied by a transfer function having a linear component.

26. The method according to claim 25, wherein the display luminance is varied based on the relationship L_{OP}=m*T_{K}+b. where L_{OP} is the display luminance, m is a gain, T_{K} is the temperature of the OLED display, and b is an offset.

27. The system according to claim 16, wherein the display luminance is varied based on a luminance degradation function.

28. A system to compensate for luminance degradation of an OLED display, the system comprising:
a controller coupled to the OLED display and configured to provide power to the OLED display thereby controlling the display luminance; and
a temperature sensor proximate the OLED display and in electrical communication with the controller, wherein the controller is configured to vary the display luminance, based on a temperature measured by the temperature sensor.

29. The system according to claim 28, wherein the controller is configured to decrease the display luminance as the temperature of the OLED display increases.

30. The system according to claim 28, wherein the controller is configured to increase the display luminance as the temperature of the OLED display decreases.

31. The system according to claim 28, wherein the controller is configured to vary the display luminance based on a transfer function having a linear term.

32. The system according to claim 31, wherein the controller is configured to vary the display luminance based on the relationship L_{OP}=m*T_{K}+b. where L_{OP} is the display luminance, m is a gain, T_{K} is the temperature of the OLED display, and b is an offset

33. The system according to claim 28, wherein the controller is configured to define a first and second temperature range and vary the luminance of the OLED display over the first temperature range based on the temperature of the OLED display.

34. The system according to claim 33, wherein the controller is configured to control the luminance of the OLED display to remain a constant value over the second temperature range.

35. The system according to claim 34, wherein a lowest temperature of the first range is between 20° and 30° C.

36. The system according to claim 33, wherein the luminance is at about 100% of full power luminance at the lowest temperature of the first range.

37. The system according to claim 36, wherein the luminance is at about 50% of the full power luminance at between 80° and 90° C.

38. The system according to claim 33, wherein the display luminance in the first temperature range is varied by a transfer function having a linear component.

39. The system according to claim 38, wherein the display luminance is varied based on the relationship L_{OP}=m*T_{K}+b. where L_{OP} is the display luminance, m is a gain, T_{K} is the temperature of the OLED display, and b is an offset.

40. The system according to claim 28, wherein the display luminance is varied based on a luminance degradation function.

41. The system according to claim 40, wherein the display luminance is varied based on a transfer function having an inversely proportional relationship to the luminance degradation function.
